(19) United States
(12) Patent Application Publication
(10) Pub. No.: US 2007/0041424 A1
(43) Pub. Date: Feb. 22, 2007

(54) Axillary thermometer

(76) Inventors: Mordechai Lev, West Bloomfield, MI (US); Rafael Kobi, Hod Haabaron (IL)

Correspondence Address: BROOKS KUSHMAN P.C., 1000 TOWN CENTER, TWENTY-SECOND FLOOR, SOUTHFIELD, MI, 48075, US

(21) Appl. No.: 11/501,261

(22) Filed: Aug. 9, 2006

Related U.S. Application Data
(60) Provisional application No. 60/708,591, filed on Aug. 16, 2005.

(51) Int. Cl. G01K 1/00; G01K 7/00

(52) U.S. Cl. 374/163; 374/208

(57) ABSTRACT

An axillary thermometer for measuring the temperature of the patient is provided. The axillary thermometer is of generally arcuate shape permitting it to conform to a patient's upper arm when temperature measurements are being administered. The probe of the thermometer is shaped such that it fits snugly and comfortably in the axillary region of the patient and includes a temperature sensor positioned about the probe for obtaining the most accurate measurements. The arcuate design and probe configuration of the axillary thermometer enhances the temperature measuring process in the axillary region.

### CROSS-REFERENCE TO RELATED APPLICATIONS

This application claims the benefit of U.S. Provisional Application Ser. No. 60/708,591, filed Aug. 16, 2005.

### BACKGROUND

Body temperature is a measure of the body's ability to generate and get rid of heat. The body is very good at keeping its temperature within a narrow, safe range in spite of large variations in temperatures outside the body. When the body gets too hot, the blood vessels in the skin expand to carry the excess heat to the skin's surface. The body may begin to sweat, and as the sweat evaporates it helps cool the body. When the body gets too cold, the blood vessels contract so that blood flow to the skin is reduced to conserve body heat. The body may start shivering, which is an involuntary, rapid contraction of the muscles. This extra muscle activity helps generate more heat. Under normal conditions, these processes effectively regulate your body temperature.

Thermometers are devices which can be used to measure body temperature. Body temperature can be measured at a host of areas including the mouth, ear, rectum, forehead, or armpit. From children to the elderly, measuring body temperature can be an important factor in the treatment of problems or diseases of patients. Thus, determining an individual's body temperature in an accurate, noninvasive manner is essential to providing proper care to a patient. Unfortunately, many patients view the temperature taking process as invasive and uncomfortable, especially children.

Traditional digital “stick” thermometers can be used in the oral, rectal, and armpit (axillary) regions and typically include an elongated probe having a thermistor. The probe is applied to the particular location on the patient's body, allowing the temperature of the thermistor and probe to rise to the patient temperature, which is then displayed on the thermometer. However, traditional “stick” thermometers are not optimal for accurate temperature measurement in the axillary region. For example, these thermometers have a tendency to move around and lack the ability to maintain sufficient, constant contact with the axilla, and more particularly, the region near the axillary artery. The more uncomfortable a child or other patient becomes, the more the patient squirms making it nearly impossible to obtain an accurate temperature measurement in the axillary region.

Information relevant to attempts to address these problems can be found in U.S. Patent Application Publication No. 2004/0170216. However, the body of these thermometers extends directly outward away from the patient's body where it is in danger of being meddled with or simply moving around on its own, preventing the probe from making good contact with the axillary region for any extended period of time. Moreover, such design often requires a parent administering the temperature taking process of a child to hold the dangling end of the thermometer body in place, while simultaneously holding the child's arm against the child's body. This becomes problematic if the child squirms because the parent has no remaining hands with which to hold the child still.

### BRIEF DESCRIPTION OF THE DRAWINGS

The present invention, both as to its organization and manner of operation, together with features and advantages thereof, may best be understood with reference to the following description taken in conjunction with the accompanying drawings of which:

FIG. 1 shows a perspective view of an axillary thermometer embodying features of the present invention for measuring body temperature;

FIG. 2 shows a plan view of the axillary thermometer of FIG. 1 embodying features of the present invention for measuring body temperature;

FIG. 3 shows another plan view of the axillary thermometer of FIG. 1 embodying features of the present invention;

FIG. 4 shows another perspective view of the axillary thermometer of FIG. 1 embodying features of the present invention;

FIG. 5 shows the axillary thermometer embodying features of the present invention in place in the underarm region of a child; and

FIG. 6 shows a general schematic of the axillary thermometer electronics embodying features of the present invention.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale, and some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

Referring now to the drawings, the present invention is directed to an axillary thermometer 10 that is designed for taking the temperature of an individual via that individual's axillary region. The shape and design of the axillary thermometer 10 may allow for improved placement into the axillary region and may provide an improved ability to remain securely in place in the axillary region. This can result in increased comfort for the patient, improved sensing capabilities, and a more precise temperature determination. The axillary thermometer 10 embodying features of the present invention can be especially advantageous when measuring the a child's body temperature since the armpit is a popular location for such measurements in children. Of course, the axillary thermometer 10 of the present invention can be equally effective for measuring the body temperature of individuals of all ages.

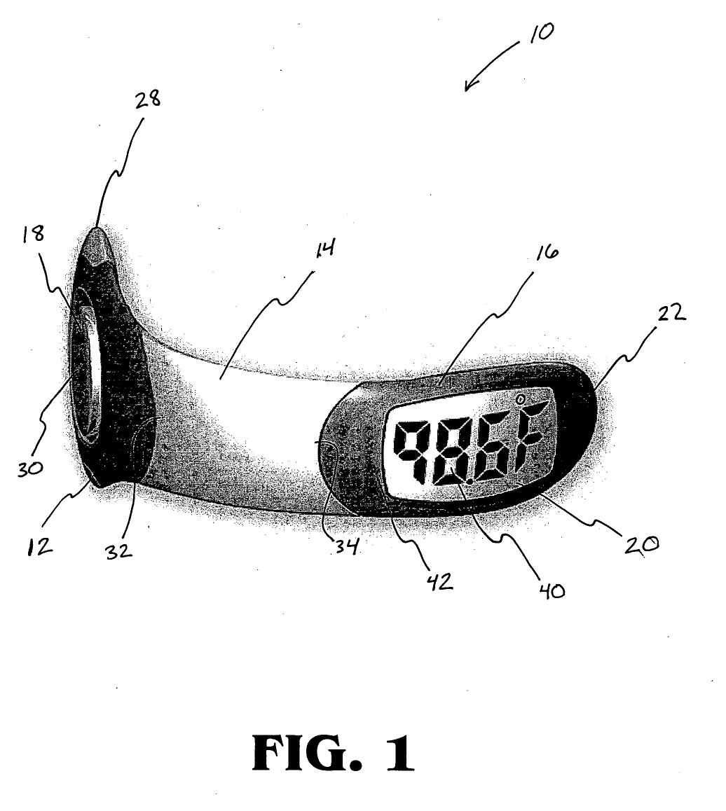

As shown in FIG. 1, the axillary thermometer 10 according to an aspect of the present invention comprises a probe 12 attached to one end of an arm band 14 and a display member 16 affixed to another end of the arm band 14. The probe 12 contains a temperature sensor 18 for sensing the body temperature of the axillary region of a patient. The display member 16 includes a temperature display 20 and an activation switch 22.

The probe 12 can have a generally triangular profile with a rounded corners for providing a snug fit in the axillary region, as best shown in FIG. 3. Of course, other shapes of the probe for providing a snug, comfortable fit are also fully contemplated. Moreover, the probe 12 may be substantially flat in that it includes an inner probe surface 24 and an outer probe surface 26 essentially parallel to one another. Of course, the inner probe surface 24 and the outer probe surface 26 may not be perfectly parallel as they meet at the outer periphery of the probe 12 forming a peripheral edge 28. The peripheral edge 28 may be rounded so as to eliminate any unnecessary sharp edges. This design may provide optimal comfort to the patient when the probe 12 is positioned in the axilla while the patient's arm is placed at the side of the body. Meanwhile, the shape of the probe 12 permits it to be optimally placed in the axillary region for taking accurate body temperature measurements.

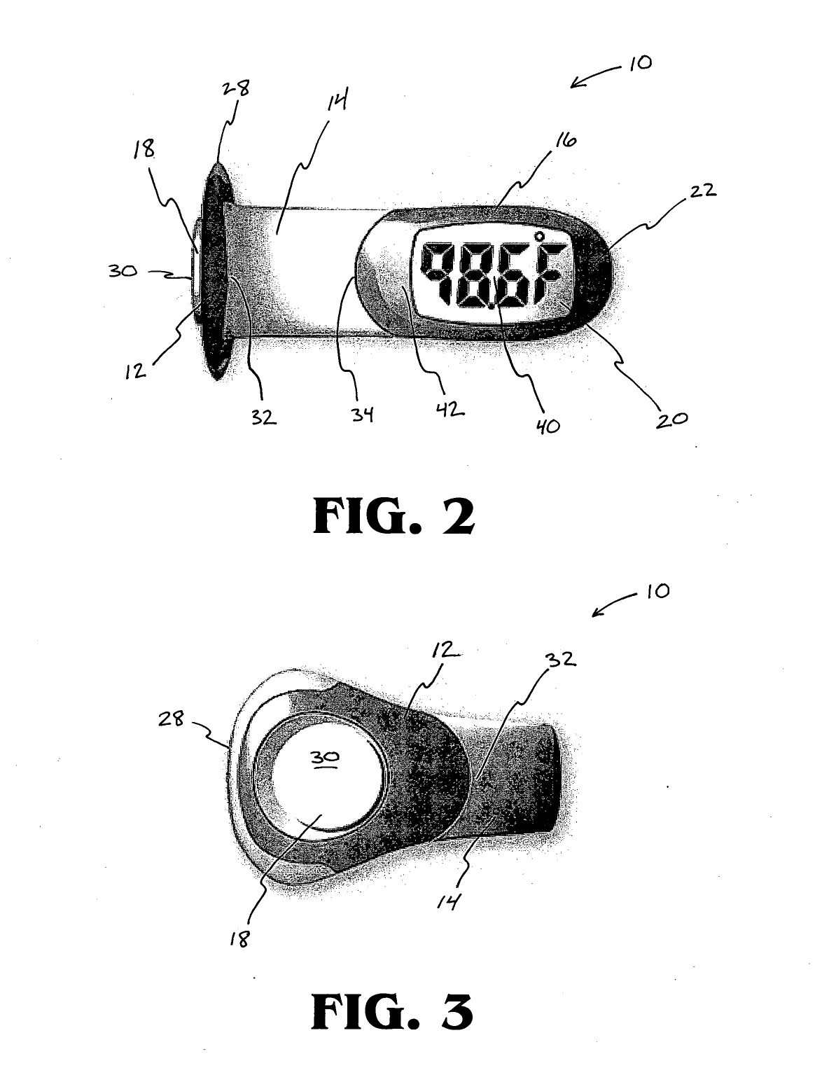

As previously mentioned, the probe 12 contains a temperature sensor 18 for measuring the temperature of the armpit. The temperature sensor 18 may be formed integrally with the probe 12 or properly affixed thereto. The temperature sensor 18 may be disposed inward of the peripheral edge 28 as shown in FIGS. 1-4. Alternatively, the temperature sensor 18 may be positioned along the peripheral edge 28 of the probe 12. In fact, the temperature sensor 18 may be located anywhere along the probe 12 without exceeding the scope of the present invention. Regardless of its placement on the probe 12, the temperature sensor 18 may include at least one exposed contact surface 30 for making direct contact with a patient's skin when placed in the axillary region.

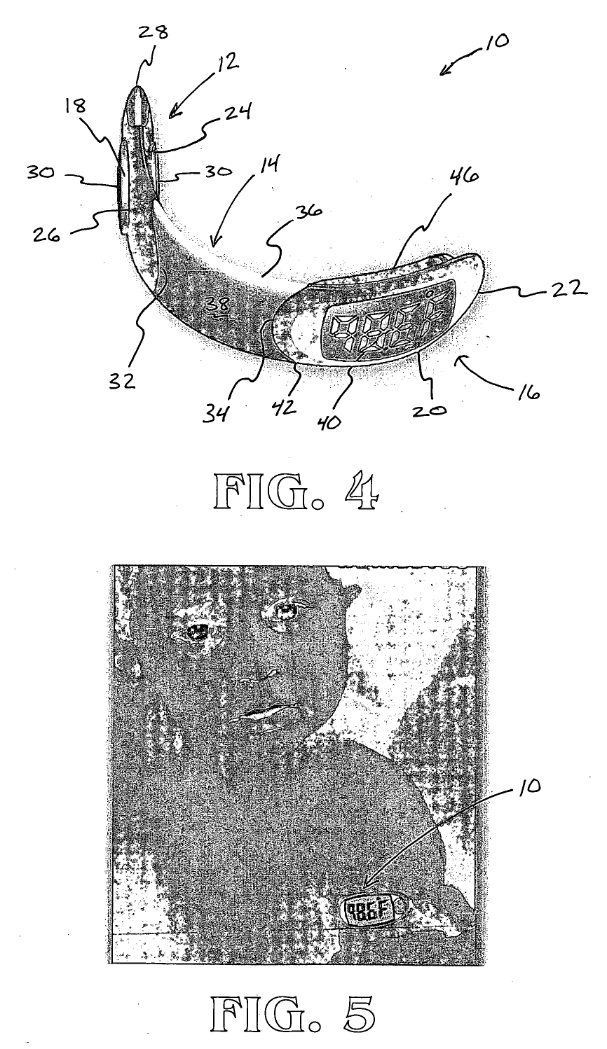

Best shown in FIGS. 1 and 4, the arm band 14 may be an elongate, arcuately shaped band having a generally rectangular profile. The arm band 14 includes a proximal end 32 and a distal end 34. The probe 12 may be connected to the proximal end 32, while the display member 16 may be connected to the distal end 34. Moreover, the arm band 14 may include an inner arcuate surface 36 and an outer arcuate surface 38. The arm band 14 may be flexible such that it can conform to the shape of a patient's arm. Once the arm band 14 is flexed to fit around the patient's arm, it may hold its form absent an applied external force. The arm band 14 may be formed from any suitable material, such as plastic or metal. Whatever the chosen material, the arm band 14 can be sufficiently flexible to adjust shape if adequate force is applied, but sufficiently rigid to maintain shape absent the requisite external force. Thus, the arcuate shape of the arm band 14 can be modified to conform comfortably to any upper arm size and shape.

Alternatively, the arm band 14 may be generally rigid and unflexible. Accordingly, its arcuate shape may fit generically to patients of a particular age group, gender or size. Thus, whether rigid or flexible, the arm band 14 may be capable of wrapping generally around the upper arm of a patient to ease the administering of body temperature measurements and to promote comfort and accuracy.

Referring now to FIGS. 1, 2, and 4, the display member 16 of the axillary thermometer 10 is described in greater detail. The display member 16 may also have an arcuate contour not unlike that of the arm band 14. The display member 16 may be connected to the arm band 14 and extend therefrom maintaining the overall generally arcuate shape of the arm band when wrapped around a patient's arm. To this end, the inner arcuate surface 36 and outer arcuate surface 38 of the arm band 14 may extend to the display member 16. Thus, the display member 16 may likewise substantially conform to the patient's upper arm. In one aspect of the invention, the display member 16 may be rigid. However, it is fully contemplated that the display member 16 may also be flexible. This design permits the entire axillary thermometer 10 to generally conform to the upper arm region of a patient.

Alternatively, the display member 16 may simply be affixed to or disposed upon the distal end 34 of the arm band 14 such that it is part of the arm band itself. Accordingly, the display member 16 may share similar characteristics as the arm band 14.

The temperature display 20 provides a user with digitally displayed readouts of a patient's body temperature, and can be read simultaneously with the temperature taking process. The temperature display 20 may be an LCD screen 40 positioned behind a protective lens 42. The lens 42 protects the display 20 from abrasions and damage caused by water, dirt, or debris and may be rounded to correspond with the arcuate contour of the display member 16 or arm band 14 or both. The display 20 may be aligned such that it faces opposite the patient's upper arm when in use. For example, the display 20 may be disposed along the outer arcuate surface 38 of the display member 16. Of course, it is fully contemplated that the display 20 may be positioned anywhere that may provide convenient viewing by a user.

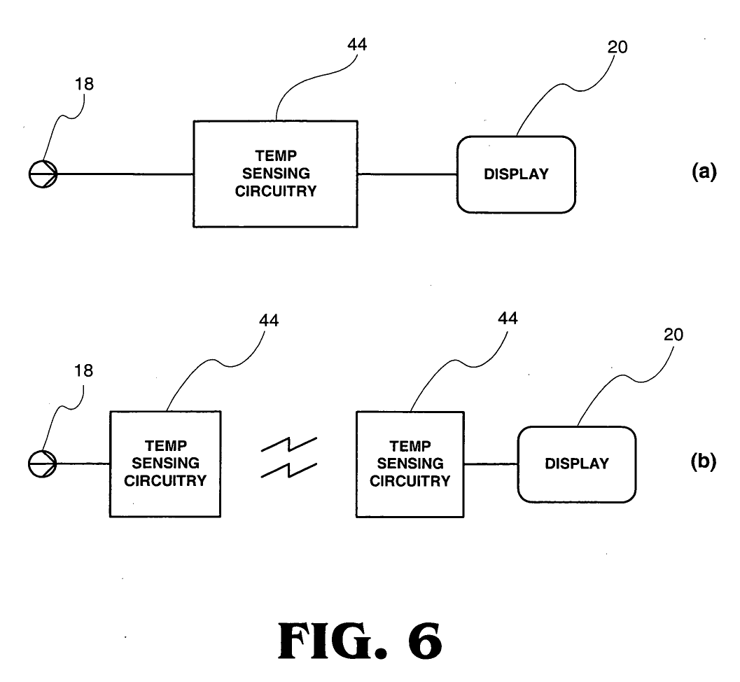

With regard to FIG. 6, the temperature sensor 18 communicates with the temperature display 20 through temperature sensing circuitry 44. The temperature sensing circuitry 44 may include a wired connection between the temperature sensor 18 and the display 20, as shown in FIG. 6(a). Alternatively, the temperature sensor input may be transmitted wirelessly for eventual output to the display 20, as depicted in FIG. 6(b). According to one aspect of the present invention, the temperature sensing circuitry 44 is self-contained within the axillary thermometer 10 itself, which acts as a protective sheath for the delicate electronics. The activation switch 22 may be disposed on the outer surface of the display member 16 or, alternately, in any convenient location upon the axillary thermometer 10. The activation switch 22 functions to toggle the axillary thermometer 10 between ON and OFF. Thus, depressing the activation switch 22 once can turn the axillary thermometer 10 on so that it is ready to take the temperature of a patient. When a user is finished with taking body temperature measurements, the axillary thermometer 10 may be turned off by depressing the activation switch 22 a second time. Alternatively, the axillary thermometer 10 may shut off on its own after a sufficient amount of time elapses.

As shown in FIG. 4, the axillary thermometer 10 may further include an arm pad 46 adhesively or otherwise affixed to the inner arcuate surface 36 of the arm band 14 or display member 16 or both. The arm pad 46 may be a thin piece of foam or rubber shaped similar to the arm band 14 or display member 16 and used to cushion the contact between the arm band 14 or display member 16 and a patient's upper arm. In addition to softening the contact between the arm band 14 or display member 16 and a patient's arm, the arm pad 46 may supply extra friction therebetween which can help prevent the axillary thermometer 10 from slipping against the skin.

FIG. 5 illustrates how the axillary thermometer 10, according to certain aspects of the present invention, can be used. The probe 12 may be inserted into the axillary region where it fits snugly and comfortably. The design of the probe 12 can minimize the discomfort to the patient, and can thereby minimize the amount of movement caused by the discomfort, especially when the patient is a child. The arm band 14 can be flexed around the upper arm of the patient such that the arm band 14 and display member 16 wrap around the upper arm much like a bracelet. Alternatively, an arcuately shaped arm band may already conform generally to the shape of the patient's upper arm. Accordingly, the axillary thermometer 10 is more apt to stay in place once the temperature taking process begins, enhancing the thermometer's precision. Further, this design permits an individual administering the temperature taking process to use only one hand to hold both the axillary thermometer 10 and the patient's arm in place. Thus, a second hand is free to attend to other matters or help in holding the patient still.

Once in place, the temperature taking process may begin. The patient or administrator of the temperature taking process can activate the axillary thermometer 10 by pressing the activation switch 22. Of course, it is fully contemplated that the activation switch 22 can be depressed to turn the thermometer on before it is positioned in the axillary region. Once situated and turned on, the axillary thermometer 10 begins taking temperature readings and outputs the corresponding temperature via the temperature display 20. Optionally, an alarm or beep may sound when the final temperature measurement has been displayed or when the temperature readings have stabilized. When the temperature taking process is completed, the axillary thermometer 10 may be removed from the patient's underarm and the activation switch 22 depressed in order to turn off the device. Alternatively, the axillary thermometer 10 may shut off on its own after a specified amount of time has elapsed.

The previously described versions of the present invention have many advantages, including the ability to take more consistent and accurate body temperature measurements in the axillary region, a common place for taking the temperature of a child. Additionally, the overall temperature taking experience can be more pleasant and less cumbersome, which can also aid in achieving accurate results. Moreover, the flexibility of the arm band 14 permits any patient and/or administrator of the temperature taking process to enjoy these features, regardless of the myriad of upper arm shapes and sizes that can be found in a typical household.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An axillary thermometer for measuring the temperature of a patient comprising:
a probe having a generally rounded peripheral edge, the probe including a temperature sensor disposed inward of the peripheral edge and having at least one exposed contact surface for contact with a patient's skin;
an elongate band having a proximal end attached to the probe and a distal end opposite the probe, the band arranged to be positioned on the patient's upper arm; and
a display member affixed to the distal end of the band, the display member including a display for revealing the patient's temperature once obtained.

2. The axillary thermometer of claim 1, wherein the elongate band can be flexed to conform to the patient's upper arm.

3. The axillary thermometer of claim 1, wherein the display member is generally arcuate in shape having an inner arcuate surface and an outer arcuate surface.

4. The axillary thermometer of claim 1, wherein the probe has a generally triangular profile with rounded corners.

5. The axillary thermometer of claim 3, further comprising a pad affixed to the inner arcuate surface of the display member.

6. The axillary thermometer of claim 3, wherein the display is disposed along the outer arcuate surface of the display member.

7. The axillary thermometer of claim 1, wherein the display is aligned such that it faces opposite the patient's upper arm when in use.

8. The axillary thermometer of claim 1, further comprising an activation switch and temperature sensing circuitry, wherein the temperature sensor and display are activated by the activation switch, and the temperature sensor and display communicate via the temperature sensing circuitry.

9. The axillary thermometer of claim 8, wherein the temperature sensing circuitry is self-contained within the probe, arcuate band and display member.

10. The axillary thermometer of claim 8, wherein the temperature sensing circuitry includes wireless components for transmitting temperature measurements from the temperature sensor to the display.

11. The axillary thermometer of claim 8, wherein the axillary thermometer shuts down automatically after a predetermined amount of time.

12. The axillary thermometer of claim 1, wherein the probe is generally thin and flat.

13. An axillary thermometer for measuring the temperature of a patient comprising:
a probe having a generally rounded peripheral edge, the probe including a temperature sensor attached thereto;
an elongate, arcuate band capable of conforming to the patient's upper arm, the arcuate band having a proximal end attached to the probe and a distal end opposite the probe; and
a display member affixed to the distal end of the arcuate band, the display member including a display for revealing the patient's temperature once obtained.

14. The axillary thermometer of claim 13, wherein the temperature sensor is disposed inward of the peripheral edge and includes at least one exposed contact surface for contact with a patient's skin.

15. The axillary thermometer of claim 13, wherein the temperature sensor is disposed along the peripheral edge.

16. The axillary thermometer of claim 13, wherein the arcuate band can be flexed to conform to the patient's upper arm.

17. The axillary thermometer of claim 13, wherein the display is aligned such that it faces opposite the patient's upper arm when in use.

18. The axillary thermometer of claim 13, further comprising an activation switch and temperature sensing circuitry, wherein the temperature sensor and display are activated by the activation switch, and the temperature sensor and display communicate via the temperature sensing circuitry.

19. The axillary thermometer of claim 13, wherein the probe is generally thin and flat.

20. An axillary thermometer for measuring the temperature of a patient in the axillary region comprising:
a generally flat probe having a generally rounded peripheral edge, the flat probe including an integrally formed temperature sensor disposed inward of the peripheral edge and having an exposed contact surface for taking temperature measurements;
an elongate, flexible arm band capable of conforming to the patient's upper arm, the arm band having a proximal end attached to the flat probe and a distal end opposite the flat probe; and
a display member affixed to the distal end of the arm band, the display member including a display for revealing the patient's temperature, the display is aligned such that it faces opposite the patient's upper arm when in use.

21. The axillary thermometer of claim 20, wherein the flexible band retains sufficient rigidity to maintain its shape absent sufficient external forces.
